(19) United States
(12) Patent Application Publication
(10) Pub. No.: US 2020/0162260 A1
(43) Pub. Date: May 21, 2020

(54) Blockchain Ledger for Persisting and Verifying Oil and Gas Events

(71) Applicant: Schlumberger Technology Corporation, Sugar Land, TX (US)

(72) Inventors: Carlos Boneti, Saratoga, CA (US); Christopher Leader, San Francisco, CA (US)

(21) Appl. No.: 16/193,497

(22) Filed: Nov. 16, 2018

(51) Int. Cl. H04L 9/32; G06F 17/30; G06F 9/54; H04L 29/08

(52) U.S. Cl. CPC H04L 9/3236; G06F 17/30283; G06F 9/54; H04L 63/0428; H04L 67/10; H04L 2209/38; G06F 17/30339

(57) ABSTRACT

Methods, apparatuses, and computer-readable media are set forth for logging oil and gas events using a combination of a primary database that stores event data for an oil and gas event along with a blockchain ledger that stores one or more identifying characteristics of the event (e.g., a hash of the event data), thereby enabling the event data to be verified. By utilizing the combination of a primary database and a blockchain ledger, the blockchain ledger is not required to store all of the data associated with an event. As such, where an oil and gas event is associated with a large volume of data, the size and thus the processing overhead associated with the blockchain ledger may be reduced.

### BACKGROUND

Within the oil and gas industry, assets, transactions, computer activity logs and other types of data are often tracked to ensure that secure and trusted records of various transactions are maintained. With the increasing use of shared computing infrastructures, such as public cloud infrastructures, maintaining secure and trusted records of transactions becomes even more important. Various entities and regulators must be able to trust that the records are accurate and have not been modified or altered in any way, even when those records were created or maintained by other entities. Moreover, the oil and gas industry creates colossal volumes of data regarding various oil and gas-related activities, including, for example, petrophysical logs generated by downhole tools, which can present difficulties in terms of maintaining and protecting that data.

As an example, petrophysical logs created by various downhole tools during drilling or production may be shared between oil services firms and their customers, and generally those logs are maintained for only a limited period of time and deleted thereafter. Moreover, the logs are generally not tamper-proof, and thus even if the logs are still available months or years after being created, there is generally no assurance that the logs have not been modified since they were created and stored. The logs may also include massive amounts of data potentially spanning months or years (e.g., in the case of production data).

### SUMMARY

Methods, apparatuses, and computer-readable media are set forth for logging oil and gas events using a combination of a primary database that stores event data for an oil and gas event along with a blockchain ledger that stores one or more uniquely identifying characteristics of the event (e.g., a hash of the event data), thereby enabling the event data to be irrefutably verified. By utilizing the combination of a primary database and a blockchain ledger, the blockchain ledger is not required to store all of the data associated with an event. As such, where an oil and gas event is associated with a large volume of data, the size and thus the processing overhead associated with using the blockchain ledger may be reduced. Moreover, uniquely identifying characteristics of confidential data may be stored in a multi-tenant blockchain ledger in some embodiments, since observers of the chain in such embodiments generally cannot reconstruct oil and gas events from these identifiers.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described example embodiments of the invention. This summary is merely provided to introduce a selection of concepts that are further described below in the detailed description, and is not intended to identify key or essential features of the claimed subject matter, nor is it intended to be used as an aid in limiting the scope of the claimed subject matter.

### BRIEF DESCRIPTION OF THE DRAWINGS

FIGS. 1.1-1.4 illustrate simplified, schematic views of an oilfield having subterranean formation containing reservoir therein in accordance with implementations of various technologies and techniques described herein.

FIG. 2 illustrates a schematic view, partially in cross section of an oilfield having a plurality of data acquisition tools positioned at various locations along the oilfield for collecting data from the subterranean formations in accordance with one or more embodiments.

FIG. 3 illustrates a production system for performing one or more oilfield operations in accordance with one or more embodiments.

FIG. 4 illustrates an example computing system that can implement the various functions and features described herein.

FIG. 5 illustrates an example network that can implement the various functions and features described herein.

FIG. 6 illustrates an example block diagram of an example computing system architecture that can implement the various functions and features described herein.

### DETAILED DESCRIPTION OF THE INVENTION

The embodiments discussed hereinafter utilize various techniques to implement a blockchain ledger for persisting and verifying oil and gas transactions. Prior to a discussion of these techniques, however, an overview of oilfield operations is provided, as is an example hardware and software environment within which the herein-described concepts may be implemented.

Specific embodiments will now be described in detail with reference to the accompanying figures. Like elements in the various figures are denoted by like reference numerals for consistency. In the following detailed description of embodiments, numerous specific details are set forth in order to provide a more thorough understanding of the embodiments. However, it will be apparent to one of ordinary skill in the art that various embodiments may be practiced without these specific details. In other instances, well-known features have not been described in detail to avoid unnecessarily complicating the description.

### Oilfield Operations

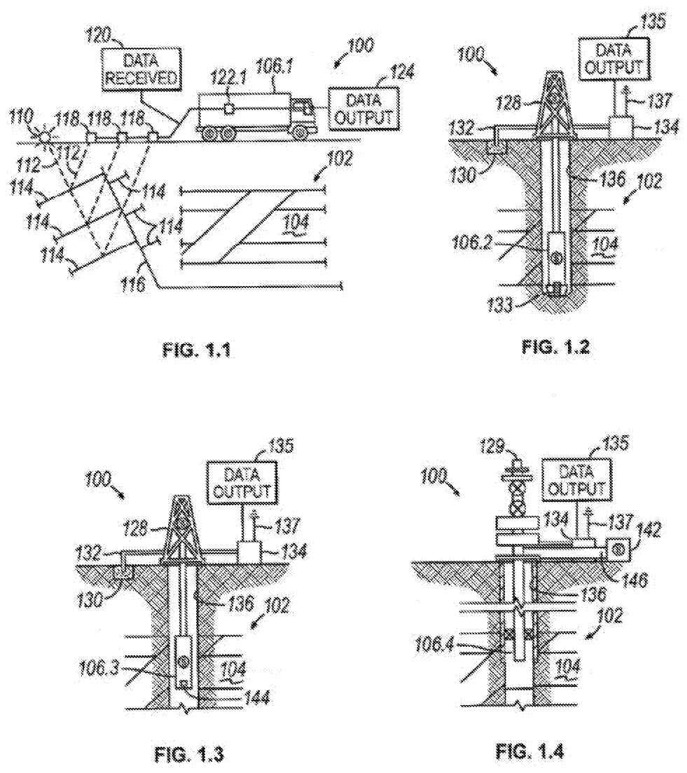

FIGS. 1.1-1.4 illustrate simplified, schematic views of an oilfield 100 having subterranean formation 102 containing reservoir 104 therein in accordance with implementations of various technologies and techniques described herein. FIG. 1.1 illustrates a survey operation being performed by a survey tool, such as seismic truck 106.1, to measure properties of the subterranean formation. The survey operation is a seismic survey operation for producing sound vibrations. In FIG. 1.1, one such sound vibration, sound vibration 112 generated by source 110, reflects off horizons 114 in earth formation 116. A set of sound vibrations is received by sensors, such as geophone-receivers 118, situated on the earth's surface. The data received 120 is provided as input data to a computer 122.1 of a seismic truck 106.1, and responsive to the input data, computer 122.1 generates seismic data output 124. This seismic data output may be stored, transmitted or further processed as desired, for example, by data reduction.

FIG. 1.2 illustrates a drilling operation being performed by drilling tools 106.2 suspended by rig 128 and advanced into subterranean formations 102 to form wellbore 136. Mud pit 130 is used to draw drilling mud into the drilling tools via flow line 132 for circulating drilling mud down through the drilling tools, then up wellbore 136 and back to the surface. The drilling mud is generally filtered and returned to the mud pit. A circulating system may be used for storing, controlling, or filtering the flowing drilling muds. The drilling tools are advanced into subterranean formations 102 to reach reservoir 104. Each well may target one or more reservoirs. The drilling tools are adapted for measuring downhole properties using logging while drilling tools. The logging while drilling tools may also be adapted for taking core sample 133 as shown.

Computer facilities may be positioned at various locations about the oilfield 100 (e.g., the surface unit 134) and/or at remote locations. Surface unit 134 may be used to communicate with the drilling tools and/or offsite operations, as well as with other surface or downhole sensors. Surface unit 134 is capable of communicating with the drilling tools to send commands to the drilling tools, and to receive data therefrom. Surface unit 134 may also collect data generated during the drilling operation and produces data output 135, which may then be stored or transmitted.

Sensors (S), such as gauges, may be positioned about oilfield 100 to collect data relating to various oilfield operations as described previously. As shown, sensor (S) is positioned in one or more locations in the drilling tools and/or at rig 128 to measure drilling parameters, such as weight on bit, torque on bit, pressures, temperatures, flow rates, compositions, rotary speed, and/or other parameters of the field operation. Sensors (S) may also be positioned in one or more locations in the circulating system.

Drilling tools 106.2 may include a bottom hole assembly (BHA) (not shown), generally referenced, near the drill bit (e.g., within several drill collar lengths from the drill bit). The bottom hole assembly includes capabilities for measuring, processing, and storing information, as well as communicating with surface unit 134. The bottom hole assembly further includes drill collars for performing various other measurement functions.

The bottom hole assembly may include a communication subassembly that communicates with surface unit 134. The communication subassembly is adapted to send signals to and receive signals from the surface using a communications channel such as mud pulse telemetry, electro-magnetic telemetry, or wired drill pipe communications. The communication subassembly may include, for example, a transmitter that generates a signal, such as an acoustic or electromagnetic signal, which is representative of the measured drilling parameters. It will be appreciated by one of skill in the art that a variety of telemetry systems may be employed, such as wired drill pipe, electromagnetic or other known telemetry systems.

Generally, the wellbore is drilled according to a drilling plan that is established prior to drilling. The drilling plan generally sets forth equipment, pressures, trajectories and/or other parameters that define the drilling process for the wellsite. The drilling operation may then be performed according to the drilling plan. However, as information is gathered, the drilling operation may need to deviate from the drilling plan. Additionally, as drilling or other operations are performed, the subsurface conditions may change. The earth model may also need adjustment as new information is collected.

The data gathered by sensors (S) may be collected by surface unit 134 and/or other data collection sources for analysis or other processing. The data collected by sensors (S) may be used alone or in combination with other data. The data may be collected in one or more databases and/or transmitted on or offsite. The data may be historical data, real time data, or combinations thereof. The real time data may be used in real time, or stored for later use. The data may also be combined with historical data or other inputs for further analysis. The data may be stored in separate databases, or combined into a single database.

Surface unit 134 may include transceiver 137 to allow communications between surface unit 134 and various portions of the oilfield 100 or other locations. Surface unit 134 may also be provided with or functionally connected to one or more controllers (not shown) for actuating mechanisms at oilfield 100. Surface unit 134 may then send command signals to oilfield 100 in response to data received. Surface unit 134 may receive commands via transceiver 137 or may itself execute commands to the controller. A processor may be provided to analyze the data (locally or remotely), make the decisions and/or actuate the controller. In this manner, oilfield 100 may be selectively adjusted based on the data collected. This technique may be used to optimize portions of the field operation, such as controlling drilling, weight on bit, pump rates, or other parameters. These adjustments may be made automatically based on computer protocol, and/or manually by an operator. In some cases, well plans may be adjusted to select optimum operating conditions, or to avoid problems.

FIG. 1.3 illustrates a wireline operation being performed by wireline tool 106.3 suspended by rig 128 and into wellbore 136 of FIG. 1.2. Wireline tool 106.3 is adapted for deployment into wellbore 136 for generating well logs, performing downhole tests and/or collecting samples. Wireline tool 106.3 may be used to provide another method and apparatus for performing a seismic survey operation. Wireline tool 106.3 may, for example, have an explosive, radioactive, electrical, or acoustic energy source 144 that sends and/or receives electrical signals to surrounding subterranean formations 102 and fluids therein. In general, wireline tool 106.3 may thereby collect acoustic data and/or image data for a subsurface volume associated with a wellbore.

Wireline tool 106.3 may be operatively connected to, for example, geophones 118 and a computer 122.1 of a seismic truck 106.1 of FIG. 1.1. Wireline tool 106.3 may also provide data to surface unit 134. Surface unit 134 may collect data generated during the wireline operation and may produce data output 135 that may be stored or transmitted. Wireline tool 106.3 may be positioned at various depths in the wellbore 136 to provide a survey or other information relating to the subterranean formation 102.

Sensors (S), such as gauges, may be positioned about oilfield 100 to collect data relating to various field operations as described previously. As shown, sensor S is positioned in wireline tool 106.3 to measure downhole parameters which relate to, for example porosity, permeability, fluid composition and/or other parameters of the field operation.

FIG. 1.4 illustrates a production operation being performed by production tool 106.4 deployed from a production unit or christmas tree 129 and into completed wellbore 136 for drawing fluid from the downhole reservoirs into surface facilities 142. The fluid flows from reservoir 104 through perforations in the casing (not shown) and into production tool 106.4 in wellbore 136 and to surface facilities 142 via gathering network 146.

Sensors (S), such as gauges, may be positioned about oilfield 100 to collect data relating to various field operations as described previously. As shown, the sensor (S) may be positioned in production tool 106.4 or associated equipment, such as christmas tree 129, gathering network 146, surface facility 142, and/or the production facility, to measure fluid parameters, such as fluid composition, flow rates, pressures, temperatures, and/or other parameters of the production operation.

Production may also include injection wells for added recovery. One or more gathering facilities may be operatively connected to one or more of the wellsites for selectively collecting downhole fluids from the wellsite(s).

While FIGS. 1.2-1.4 illustrate tools used to measure properties of an oilfield, it will be appreciated that the tools may be used in connection with non-oilfield operations, such as gas fields, mines, aquifers, storage, or other subterranean facilities. Also, while certain data acquisition tools are depicted, it will be appreciated that various measurement tools capable of sensing parameters, such as seismic two-way travel time, density, resistivity, production rate, etc., of the subterranean formation and/or its geological formations may be used. Various sensors (S) may be located at various positions along the wellbore and/or the monitoring tools to collect and/or monitor the desired data. Other sources of data may also be provided from offsite locations.

The field configurations of FIGS. 1.1-1.4 are intended to provide a brief description of an example of a field usable with oilfield application frameworks. Part, or all, of oilfield 100 may be on land, water, and/or sea. Also, while a single field measured at a single location is depicted, oilfield applications may be utilized with any combination of one or more oilfields, one or more processing facilities and one or more wellsites.

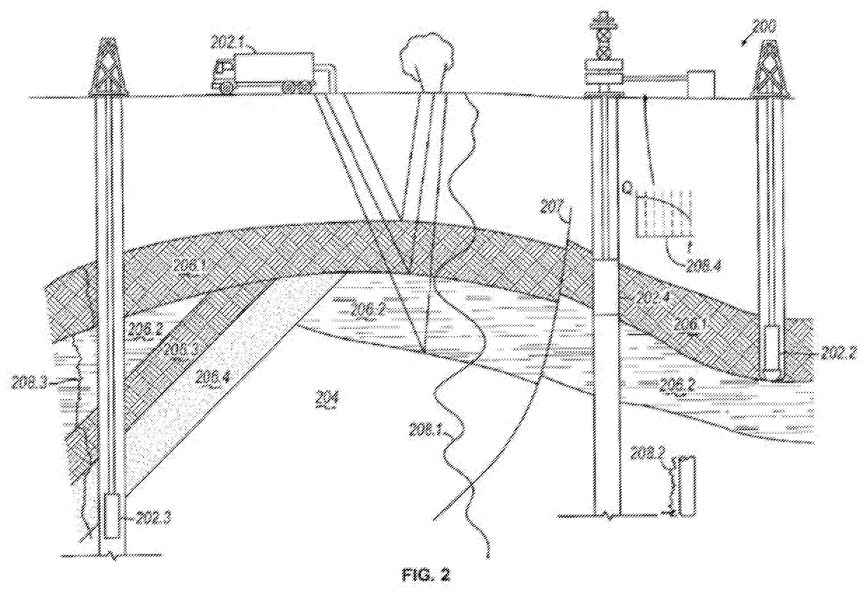

FIG. 2 illustrates a schematic view, partially in cross section of oilfield 200 having data acquisition tools 202.1, 202.2, 202.3 and 202.4 positioned at various locations along oilfield 200 for collecting data of subterranean formation 204 in accordance with implementations of various technologies and techniques described herein. Data acquisition tools 202.1-202.4 may be the same as data acquisition tools 106.1-106.4 of FIGS. 1.1-1.4, respectively, or others not depicted. As shown, data acquisition tools 202.1-202.4 generate data plots or measurements 208.1-208.4, respectively. These data plots are depicted along oilfield 200 to demonstrate the data generated by the various operations.

Data plots 208.1-208.3 are examples of static data plots that may be generated by data acquisition tools 202.1-202.3, respectively, however, it should be understood that data plots 208.1-208.3 may also be data plots that are updated in real time. These measurements may be analyzed to better define the properties of the formation(s) and/or determine the accuracy of the measurements and/or for checking for errors. The plots of each of the respective measurements may be aligned and scaled for comparison and verification of the properties.

Static data plot 208.1 is a seismic two-way response over a period of time. Static plot 208.2 is core sample data measured from a core sample of the formation 204. The core sample may be used to provide data, such as a graph of the density, porosity, permeability, or some other physical property of the core sample over the length of the core. Tests for density and viscosity may be performed on the fluids in the core at varying pressures and temperatures. Static data plot 208.3 is a logging trace that generally provides a resistivity or other measurement of the formation at various depths.

A production decline curve or graph 208.4 is a dynamic data plot of the fluid flow rate over time. The production decline curve generally provides the production rate as a function of time. As the fluid flows through the wellbore, measurements are taken of fluid properties, such as flow rates, pressures, composition, etc.

Other data may also be collected, such as historical data, user inputs, economic information, and/or other measurement data and other parameters of interest. As described below, the static and dynamic measurements may be analyzed and used to generate models of the subterranean formation to determine characteristics thereof. Similar measurements may also be used to measure changes in formation aspects over time.

The subterranean structure 204 has a plurality of geological formations 206.1-206.4. As shown, this structure has several formations or layers, including a shale layer 206.1, a carbonate layer 206.2, a shale layer 206.3 and a sand layer 206.4. A fault 207 extends through the shale layer 206.1 and the carbonate layer 206.2. The static data acquisition tools are adapted to take measurements and detect characteristics of the formations.

While a specific subterranean formation with specific geological structures is depicted, it will be appreciated that oilfield 200 may contain a variety of geological structures and/or formations, sometimes having extreme complexity. In some locations, generally below the water line, fluid may occupy pore spaces of the formations. Each of the measurement devices may be used to measure properties of the formations and/or its geological features. While each acquisition tool is shown as being in specific locations in oilfield 200, it will be appreciated that one or more types of measurement may be taken at one or more locations across one or more fields or other locations for comparison and/or analysis.

The data collected from various sources, such as the data acquisition tools of FIG. 2, may then be processed and/or evaluated. Generally, seismic data displayed in static data plot 208.1 from data acquisition tool 202.1 is used by a geophysicist to determine characteristics of the subterranean formations and features. The core data shown in static plot 208.2 and/or log data from well log 208.3 are generally used by a geologist to determine various characteristics of the subterranean formation. The production data from graph 208.4 is generally used by the reservoir engineer to determine fluid flow reservoir characteristics. The data analyzed by the geologist, geophysicist and the reservoir engineer may be analyzed using modeling techniques.

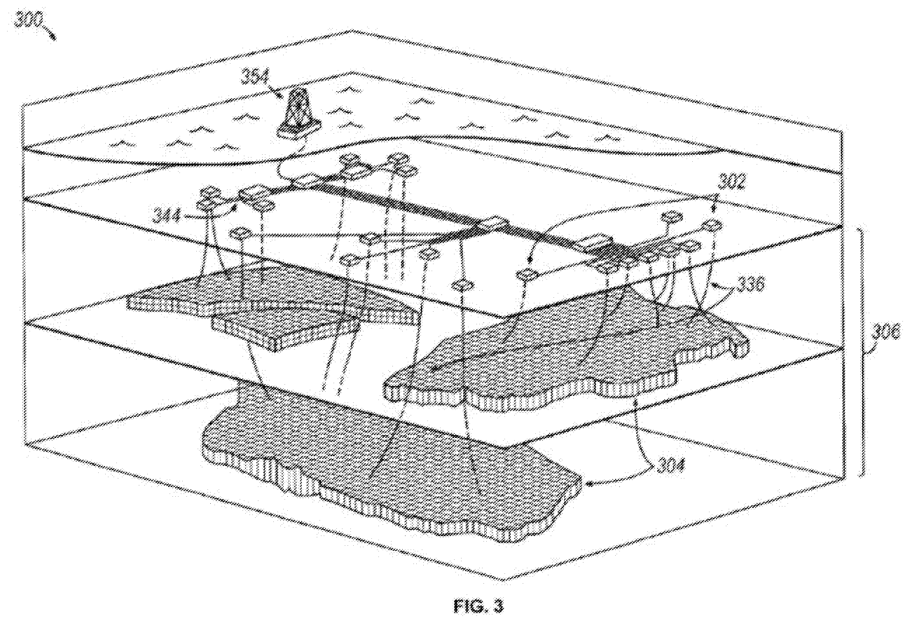

FIG. 3 illustrates an oilfield 300 for performing production operations in accordance with implementations of various technologies and techniques described herein. As shown, the oilfield has a plurality of wellsites 302 operatively connected to central processing facility 354. The oilfield configuration of FIG. 3 is not intended to limit the scope of the oilfield application system. Part, or all, of the oilfield may be on land and/or sea. Also, while a single oilfield with a single processing facility and a plurality of wellsites is depicted, any combination of one or more oilfields, one or more processing facilities and one or more wellsites may be present.

Each wellsite 302 has equipment that forms wellbore 336 into the earth. The wellbores extend through subterranean formations 306 including reservoirs 304. These reservoirs 304 contain fluids, such as hydrocarbons. The wellsites draw fluid from the reservoirs and pass them to the processing facilities via surface networks 344. The surface networks 344 have tubing and control mechanisms for controlling the flow of fluids from the wellsite to processing facility 354.

### Hardware and Software Environment

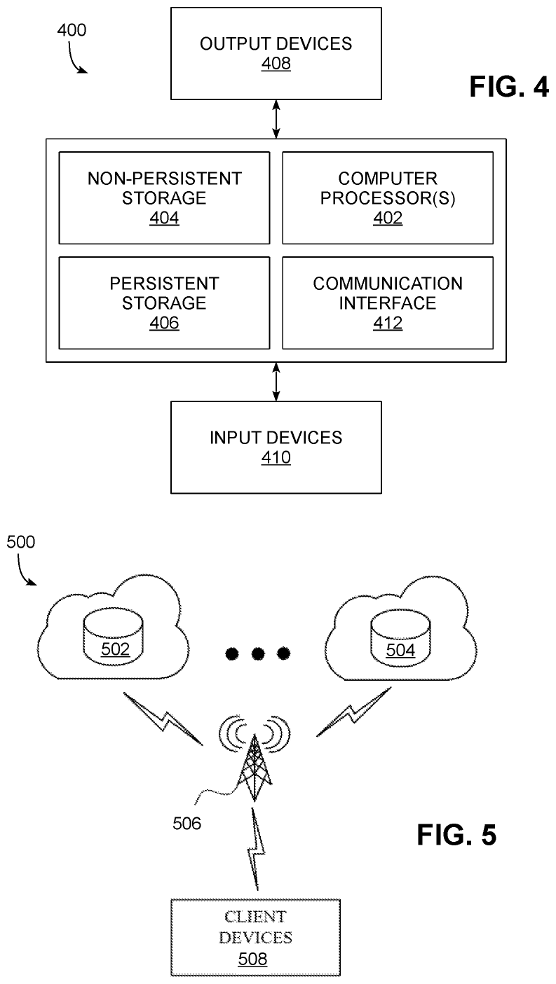

Embodiments may be implemented on a computing system. Any combination of mobile, desktop, server, router, switch, embedded device, or other types of hardware may be used. For example, as shown in FIG. 4, the computing system 400 may include one or more computer processors 402, non-persistent storage 404 (e.g., volatile memory, such as random access memory (RAM), cache memory), persistent storage 406 (e.g., a hard disk, an optical drive such as a compact disk (CD) drive or digital versatile disk (DVD) drive, a flash memory, etc.), a communication interface 412 (e.g., Bluetooth interface, infrared interface, network interface, optical interface, etc.), and numerous other elements and functionalities.

The computer processor(s) 402 may be an integrated circuit for processing instructions. For example, the computer processor(s) may be one or more cores or micro-cores of a processor. The computing system 400 may also include one or more input devices 410, such as a touchscreen, keyboard, mouse, microphone, touchpad, electronic pen, or any other type of input device.

The communication interface 412 may include an integrated circuit for connecting the computing system 400 to a network (not shown) (e.g., a local area network (LAN), a wide area network (WAN) such as the Internet, mobile network, or any other type of network) and/or to another device, such as another computing device.

Further, the computing system 400 may include one or more output devices 408, such as a screen (e.g., a liquid crystal display (LCD), a plasma display, touchscreen, cathode ray tube (CRT) monitor, projector, or other display device), a printer, external storage, or any other output device. One or more of the output devices may be the same or different from the input device(s). The input and output device(s) may be locally or remotely connected to the computer processor(s) 402, non-persistent storage 404, and persistent storage 406. Many different types of computing systems exist, and the aforementioned input and output device(s) may take other forms.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments.

The computing system 400 in FIG. 4 may be connected to or be a part of a network, such as the network 506 described by system 500 of FIG. 5. For example, as shown in FIG. 5, the network 506 may include multiple nodes (e.g., node X 502, node Y 504). Each node may correspond to a computing system, such as the computing system shown in FIG. 4, or a group of nodes combined may correspond to the computing system shown in FIG. 4. By way of an example, embodiments may be implemented on a node of a distributed system that is connected to other nodes. By way of another example, embodiments may be implemented on a distributed computing system having multiple nodes, where each portion of the embodiment may be located on a different node within the distributed computing system. Further, one or more elements of the aforementioned computing system 400 may be located at a remote location and connected to the other elements over a network.

Although not shown in FIG. 5, the node may correspond to a blade in a server chassis that is connected to other nodes via a backplane. By way of another example, the node may correspond to a server in a data center. By way of another example, the node may correspond to a computer processor or micro-core of a computer processor with shared memory and/or resources.

The nodes (e.g., node X 502, node Y 504) in the network 506 may be configured to provide services for a client device 508. For example, the nodes may be part of a cloud computing system. The nodes may include functionality to receive requests from the client device 508 and transmit responses to the client device 508. The client device 508 may be a computing system, such as the computing system shown in FIG. 4. Further, the client device 508 may include and/or perform all or a portion of one or more embodiments.

The computing system or group of computing systems described in FIGS. 4 and 5 may include functionality to perform a variety of operations disclosed herein. For example, the computing system(s) may perform communication between processes on the same or different system. A variety of mechanisms, employing some form of active or passive communication, may facilitate the exchange of data between processes on the same device. Examples representative of these inter-process communications include, but are not limited to, the implementation of a file, a signal, a socket, a message queue, a pipeline, a semaphore, shared memory, message passing, and a memory-mapped file. Further details pertaining to a couple of these non-limiting examples are provided below.

The above description of functions present only a few examples of functions performed by the computing system of FIG. 4 and the nodes and/or client device in FIG. 5. Other functions may be performed using one or more embodiments.

Those skilled in the art will recognize that the example environment illustrated in FIGS. 4 and 5 is not intended to limit the invention. Indeed, those skilled in the art will recognize that other alternative hardware and/or software environments may be used without departing from the scope of the invention.

### Blockchain Ledger for Persisting and Verifying Oil and Gas Transactions

Within the oil and gas industry, generally there is a desire to securely track assets, transactions, and activity logs, particularly as more services and platforms are residing, at least partly, in a public cloud infrastructure. As such, events such as data movement, data access, and application use, should be recorded, both securely and accurately.

Conventionally, log histories are deleted after certain time interval, and are generally not tamper-proof. In contrast, embodiments consistent with the invention may harness distributed ledger and blockchain technologies, and may utilize asset and action logging services that provide a decentralized and immutable history of key transactions and activities, in combination with an encrypted log database, such that the validity of events can be ascertained with a high degree of certainty.

In particular, in embodiments consistent with the invention, a blockchain ledger may be utilized for storing hashed details of a transaction, and a second database (referred to herein as a primary database) may be used for storing encrypted details of the activity. Under this paradigm, multiple services can log to the blockchain ledger in an effectively opaque manner. Moreover, if the hash function is known then the blockchain ledger is queryable, and can be used to verify the authenticity of the events stored in the primary database.

By doing so, events may be recorded in a manner that is both immutable and opaque, allowing, for example, a logging services entity to offer a service that records events for client entities in a way that they cannot be seen by unauthorized entities (even by the logging services entity) and effectively enables any tampering to be prevented and/or detected.

In some embodiments, for example, after a producing entity, e.g., an oilfield tool or any other entity capable of generating event data, generates an event, details of the event (referred to herein as event data) may be encrypted and stored in a primary database (e.g., for oilfield tools that generate logs, a log database). This encryption can be client entity managed (e.g., where logs arrive encrypted by their privately managed public key), or can be managed by another entity, e.g., a logging services entity such as an oilfield services entity, a data management entity, a cloud services entity, etc. (e.g., where a client entity-specific public key is used to encrypt the values, and optionally the associated keys/tags). The corresponding private key, which is needed for decryption, can also be either client entity managed or managed by another entity such as a logging services entity. Consequently, for events or transactions needing increased security, not even the logging services entity may be permitted to access the events or transactions in plain-text. This should provide an additional level of security for client entities, with the mindset of a trust-free event logging service.

A logging service consistent with some embodiments of the invention may direct encrypted event data to a primary log database, and then hash one or more identifying characteristics of the payload, along with any tags, and send these to a blockchain ledger. This type of hybrid approach has several advantages, including, for example, that the primary log database will tend to be more efficient to query, not storing all details in the blockchain ledger will generally reduce the size of the ledger, and identifying characteristics such as document fingerprints (e.g., a hashed imprint of a signed document in PDF format) can be logged into the blockchain ledger with the full document stored in the primary log database, among others.

In some embodiments, for example, software, devices, and/or users, may all forward logs of certain events to a designated REST endpoint, which functions as an API to access a logging services entity managed transaction logging service running in a cloud services provider application engine. These logs may, or may not be, already encrypted, and the logging service may then optionally encrypt the information, and then format and write the log to a primary database. The logging service may also hash any key event fields or other identifying characteristics, and forward this checksum, along with a GUID, timestamp and any search tags (which could all also be hashed) to a blockchain ledger, e.g., using a blockchain fabric such as Hyperledger Fabric and Hyperledger Composer run on Kubernetes, providing an append-only, replicated, and immutable history.

Then, later in the event of a dispute, such as security, data access, or billing, the log database information can be correlated with the corresponding blockchain entry. Additionally, in the event of a legal breach, the client entity could be compelled to provide the private keys to a governing body, thus recovering the details of the activity. Similarly, in the case of a contract where entities are non-static, upon exit or entry of a group the encryption keys can be rotated, ensuring all bodies have the correct access abilities.

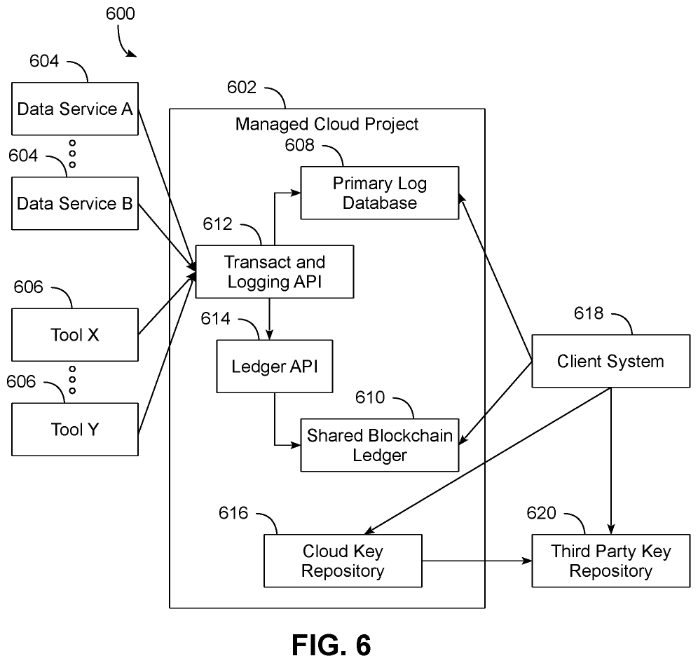

FIG. 6 illustrates an example computing system 600 that may implement the herein-described techniques. A cloud-based logging service 602 may be implemented as a managed cloud project in some embodiments, and may receive events or transactions from one or more producing entities, e.g., various data services 604 and/or various oilfield tools 606. Logging service 602 includes a primary log database 608 for use in storing event data, along with a shared blockchain ledger 610 that logs the events. A transaction and logging API 612 may be used to receive events from the producing entities and log the events by persisting (and optionally encrypting) event data in primary log database 608, hashing one or more identifying characteristics of an event and accessing a ledger API 614 to log the event in the shared blockchain ledger 610 (e.g., to store the identifying characteristics, a timestamp, a GUID, etc. in the blockchain ledger).

A cloud key repository 616 may also be provided by logging service 602 to provide access to one or more consuming entities (e.g., client systems 618), thereby enabling authorized entities to access both the event data in primary log database 608 and shared blockchain ledger 610. In some embodiments, and as represented by block 620, public and private keys may also be managed externally from logging service 602 and thus by a third party in some embodiments.

As such, when logging an event with logging service 602, one or more identifying characteristics of the event may be retrieved from the event data, the event data may be persisted in the primary log database, a hash may be performed of the event data, and an entry may be created in the blockchain ledger including the generated hash as well as the identifying characteristics and potentially additional information such as a GUID and/or timestamp. Then, later, when it is desired to verify some event data in the primary log database, the event data may be retrieved from the database and a hash may be generated of the hash data. The entry corresponding to the event may then be retrieved from the blockchain ledger and the hash stored in the entry may be compared to the generated hash. A match indicates that the event data has not been altered since stored in the primary log database, while a mismatch indicates that the event data may have been modified or is otherwise invalid.

It will be appreciated that in some embodiments, primary log database may be managed by a logging service or by a client entity, or may be shared. Encryption of event data may be performed by a client entity or within the logging service in different embodiments, and shared blockchain ledger, primary log database, and other components may be distributed among multiple computers, data centers, etc. in some embodiments.

The techniques described herein may be utilized in connection with a number of different applications within the oil and gas industry. For example, the herein-described techniques may be used in connection with asset tracking in some embodiments. Assets, in this regard, may include practically any type of physical or virtual entity for which tracking of the status of the entity may be desired. In some embodiments, for example, an asset may by a physical object having some characteristic, e.g., based upon value, hazardous nature, confidentiality, proprietary nature, etc., for which tracking of that asset may be desired.

A specific and non-limiting example is that of a gamma ray source used in well logging to estimate shale content. Gamma ray sources emit radiation and thus the use and handling of such sources generally must be controlled. Moreover, such sources are generally transported from well site to well site in order to perform logging at different well sites. Losing or misplacing such an asset can be very damaging, not only in terms of asset loss, but also in terms of reputation loss and non-productive time. If every time that such a source is moved the user sends information about the source/tool ID, the location, the destination, the time and the transporters, then a protected history may be created for the lifetime of the asset. Furthermore, details of that history will be readily accessible to a person with the correct credentials.

In addition, in the paradigm where the blockchain ledger receives additional details regarding the transaction (even the full transaction in some embodiments), the tool, user, and transporter may all be existing member assets of the system. Upon invocation of the log, the tool ID can be checked, and the user can be verified that they have the authority to log and move the source.

As another example, for drilling operations, drilling jobs many be associated with a number of actions that may be logged. These include key decision points, and anytime there has been a contract agreement. If these transactions are entered and recorded in a similar manner, via the proposed transaction API, then a tamper-proof history may be created. This may be useful for a number of scenarios, e.g., looking through the history in the event of a problem, pulling job statistics, checking histories of certain drill sites and drill engineers, etc. Doing so has an advantage over simply recorded these details on-site, since the blockchain ledger is not only tamper-proof, but accessible to anyone with the correct credentials and an internet connection. Ergo, a person, or team, in charge of multiple of drilling projects can query the database and the blockchain for real-time updates of key activities.

As mentioned above, in some embodiments, identifying characteristics such as the cryptographic fingerprint of a document (e.g., a signed contract) can be stored in the primary database and blockchain ledger, without causing the respective sizes to bloat unnecessarily. The actual location of the full document may also be encrypted and persisted, in the same manner, e.g., on a client entity managed server, on a cloud bucket, or another managed location such as that managed by a logging services entity, oil services entity, etc.

As yet another example, cloud software events, e.g., associated with seismic visualization, may be logged. Every time a user opens a certain dataset, or requests a certain sub-cube, this can be logged and forwarded. These events may occur at a much higher rate, e.g., on the minute-scale for opening data, and possibly hundreds of transactions a second for a sub-cube request.

Other applications of the aforementioned techniques within the oil and gas industry will be appreciated by those of ordinary skill having the benefit of the instant disclosure.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

We claim:

1. A method implemented by one or more processors for logging an oil and gas event, the method comprising:
receiving the oil and gas event from a producing entity, the oil and gas event including event data and one or more identifying characteristics;
persisting the event data of the oil and gas event in a primary database; and
logging the one or more identifying characteristics of the oil and gas event in an entry in the blockchain ledger.

2. The method of claim 1, wherein the producing entity is an oilfield tool, and wherein the event data for the oil and gas event includes log data collected by the oilfield tool.

3. The method of claim 1, further comprising encrypting the event data prior to persisting the event data in the primary database.

4. The method of claim 1, wherein the event data is encrypted prior to be received from the producing entity.

5. The method of claim 1, wherein the one or more identifying characteristics include a GUID, a timestamp, and/or a hash of at least a portion of the event data.

6. The method of claim 1, wherein receiving the oil and gas event, persisting the event data and logging the one or more identifying characteristics are performed by a cloud-based logging service including a transaction and logging API, a ledger API and a key repository.

7. A method implemented by one or more processors for verifying an oil and gas event, the method comprising:
retrieving event data for the oil and gas event from a primary database;
generating a hash of the event data;
retrieving a corresponding entry for the oil and gas event from a blockchain ledger; and
comparing the generated hash to a hash stored in the retrieved entry.

8. An apparatus, comprising:
one or more processors; and
program code configured upon execution by the one or more processors to perform the method of any of claims 1-7.

9. A program product, comprising:
a computer readable medium; and
program code stored on the computer readable medium and configured upon execution by one or more processors to perform the method of any of claims 1-7.

10. A method, apparatus or program product substantially as illustrated and described herein.
